(19) United States
(12) Patent Application Publication
(10) Pub. No.: US 2021/0124853 A1
(43) Pub. Date: Apr. 29, 2021

(54) SIMULATION BASED ON PRECOMPUTED RESULTS OF THE SIMULATION

(71) Applicant: Hewlett Packard Enterprise Development LP, Houston, TX (US)

(72) Inventors: Mehmet Kivanc Ozonat, Palo Alto, CA (US); Abulimiti Aji, Palo Alto, CA (US); Mehmet Oguz Sayal, Palo Alto, CA (US); Natalia Vassilieva, Palo Alto, CA (US)

(21) Appl. No.: 16/074,122

(22) PCT Filed: Apr. 5, 2016
(86) PCT No.: PCT/US2016/026051

§ 371 Date: Jul. 31, 2018

(51) Int. Cl. G06F 30/20; G06N 7/00

(52) U.S. Cl. CPC G06F 30/20; G06F 2111/10; G06N 7/005

(57) ABSTRACT

Examples herein involve preforming a simulation of a simulated model using precomputed results of the simulation with predetermined values for a parameter set of the simulated model. In examples herein, a test sample set is selected from a sample subsets repository, and using the test sample set, determining results of a simulation of the simulated model for the test parameters.

### BACKGROUND

Simulations, such as Monte Carlo simulations, may be computed to extrapolate or predict information. In some examples, multiple instances or executions of a simulation may be performed, combined, and analyzed to provide increased accuracy. Each instance may involve various values of random inputs to account for variances in the simulation. When combining the results (e.g., by averaging, weighting, etc.), the multiple computations of the simulation may provide more accurate results.

### BRIEF DESCRIPTION OF THE DRAWINGS

FIG. 1 illustrates a schematic diagram of an example fast simulation system including a fast simulation manager implemented in accordance with an aspect of this disclosure.

FIG. 2 a block diagram of an example fast simulation manager that that may be used to implement the fast simulation manager of FIG. 1.

FIG. 3 is a flowchart representative of example machine readable instructions that may be executed to implement the fast simulation manager of FIG. 2.

FIG. 4 is a block diagram of an example processor platform capable of executing the instructions of FIG. 3 to implement the fast simulation manager of FIG. 2.

Wherever possible, the same reference numbers will be used throughout the drawing(s) and accompanying written description to refer to the same or like parts.

### DETAILED DESCRIPTION

Examples disclosed herein involve performing a fast simulation for a test parameter set of a simulated model (e.g., a model that may be estimated as a simulation that uses a plurality of samples, such as a Monte Carlo simulation) using precomputed simulation results. The precomputed simulation results are computed using predetermined values for parameters of the simulated model and representative sample subsets, and stored in a sample subsets repository. In examples herein, a test sample set is selected from a sample subsets repository based on the test parameter set, and a fast simulation is performed by using the test sample set. Because results of the simulation are precomputed, a fast simulation manager may retrieve the results from a sample subsets repository. Accordingly, in examples herein, simulations can be performed in real-time by computing the simulation for the test parameters and retrieving pre-computed results from a repository, rather than simulate the test parameters on complete sample sets.

For examples herein, let

y=ƒ(X,θ) (1)

where y is an output of an example simulated model ƒ, X represents inputs (e.g., random inputs) to the simulation, and θ are parameters of the model ƒ relating the inputs to the outputs. As an example, in option pricing, the output y may be the price of a derivative of assets, θ may be a vector of simulation parameters (e.g., implied volatility, mean reversion coefficient, variance of volatility, covariances between assets underlying the derivative, etc.), and X is a vector of random inputs that may affect market behavior (e.g., Brownian motion, etc.).

Further, the output y may be given as a statistical expectation of ƒ over the inputs X, as follows:

y≈E(ƒ(X,θ)) (2)

and the expectation is taken over X. When a closed-form solution of the expectation in Equation 2 does not exist (e.g., in some cases for financial derivatives), the expectation may be estimated as follows:

$$g ( θ , {X}_{\{ N \}} ) = \frac{1}{N} {\sum }_{n = 1}^{N} f ( {X}_{n} , θ ) \qquad ( 3 )$$

where Xₙ is a n^{th} randomly selected sample according to a distribution of X, and N is the number of samples for X, and X_{{N}} refers to the set of N samples drawn according to the distribution of X. The example model of Equation 3 may be computed as a Monte Carlo simulation. In examples herein, as N approaches infinity, g approaches the statistical expectation given in Equation 2.

An example error ε of the model of Equation 3 may be given by:

ε=g(θ,X_{{N}})−E(ƒ(X,θ)) (4)

and the variance of the error ε may be:

$$E ( {ɛ}^{2} ) = {E ( g ( θ , {X}_{\{ N \}} ) - E ( f ( X , θ ) ) )}^{2} = \frac{{σ}^{2}}{α ( N )} \qquad ( 5 )$$

where the function α is increasing in N such that the error variance is inversely proportional to the number of samples N. The variance σ⁻² is the variance of the function g. As N increases and/or as the variance of g decreases, the error variance approaches zero.

In the above, it may be computationally expensive (e.g., in derivative pricing simulations) to calculate the function ƒ because the function ƒ may be an output of a path of computations that takes place over a long period of time (e.g., weeks, months, years, etc.). However, following Equation 5, very large values of N (e.g., over one million, over ten million, etc.) may be useful in achieving the most accurate results. Accordingly, it may be difficult to complete the computations in real-time (or online) settings. Examples herein seek to cure these deficiencies and computational issues using a fast simulation approach that uses simulation results that have been precomputed (or were computed offline) using standard, known, or predetermined parameter values and applying those results to test parameter sets for the fast simulation.

An example method includes receiving a test parameter set corresponding to a parameter set of simulation and selecting a test sample set from sample subsets repository of the simulation. In examples herein, sample subsets are based on simulations using predetermined simulation parameter values. Further, example methods include determining a result of the simulation of the simulated model for the test parameter set using the test sample set. Accordingly, such a method allows for a fast simulation for the test parameter set without simulating the test parameters across complete sample sets.

As used herein, a fast simulation refers to an example simulation of a simulated model performed herein using selected results of precomputed simulations of the simulated model to estimate results for test parameter sets. The precomputed simulations may be simulations using known, predetermined, expected values for parameters of a simulated model.

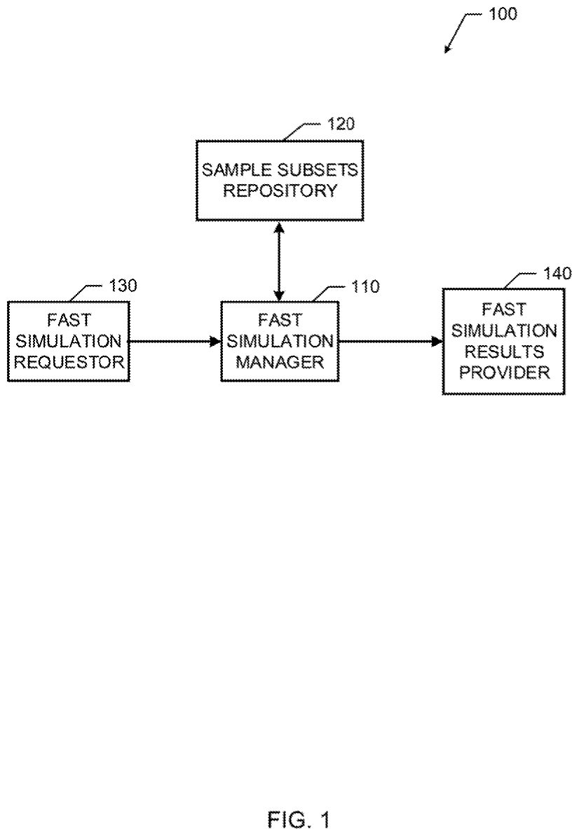

FIG. 1 is a schematic diagram of an example fast simulation system 100 including a fast simulation manager 110 constructed in accordance with examples herein. The example fast simulation system 100 of FIG. 1 includes the fast simulation manager 110, a sample subsets repository 120, a fast simulation requestor 130, and a fast simulation results provider 140. In examples herein, the simulation manager 110 handles simulation requests from the simulation requestor 130 and utilizes results from the sample subsets repository 120 to perform a fast simulation and provide results of the fast simulation via the simulation results provider 140. For example, the fast simulation manager 110 may reformulate Equation 3 in the following manner:

$$g ( θ , {X}_{\{ N \}} ) = {\sum }_{n = 1}^{N} {α}_{k} ( g ( {β}_{k} , {X}_{\{ N \}} ) + h ( θ , {β}_{k} , {X}_{\{ M \}} ) ) \qquad ( 6 )$$

where

h(θ,βₖ,X_{{M}}))=g(θ,X_{{M}})−g(βₖ,X_{{M}}) (7)

and where k is a sample of a selected subset of samples M from the sample subsets repository 120 from a set of precomputed samples N. In examples herein, the fast simulation manager 110 may select the M samples from N samples to be included in the sample subsets repository 120. For example, the fast simulation manager 110 may select the M samples from N based on a statistical distribution of N using a distance analysis (e.g., a Kolmogorov-Smirnov distance analysis). The example N samples may be received/retrieved from a database (e.g., a database separate from the sample subsets repository 120), from the fast simulation requestor 130, or from any other entity or device. The fast simulation manager 110 may then analyze the N samples and select the M samples for storage in the sample subsets repository 120.

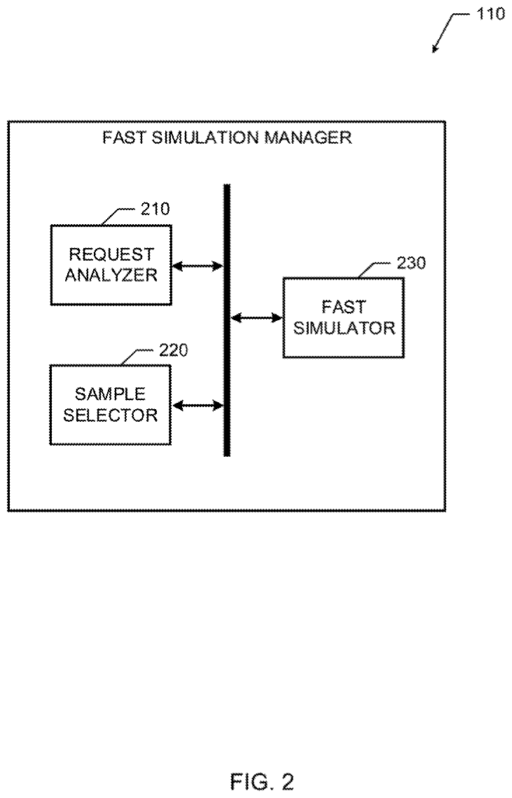

In examples herein, M is much smaller (e.g., multiple orders of magnitude, e.g., 1/100^{th}, 1/1000^{th}, 1/10,000^{th}, etc.) than N (i.e., M<<N). From Equations 6 and 7, g(βₖ, X_{{N}}), g(βₖ, X_{{M}}), and X_{{M}} may be precomputed (e.g., by the fast simulation manager 110 or other simulator) and stored in the sample subsets repository 120, such that when a test parameter set θ is received from the simulation requestor 130, the fast simulation manager 110 may retrieve the values and calculate g(θ, X_{{N}}) to determine results of a simulation for the test parameter set θ. An example implementation of the fast simulation manager 110 is discussed below in connection with FIG. 2.

The example sample subsets repository 120 includes M samples selected from precomputed simulations on complete sets of N samples (e.g., simulations of g(βₖ, X_{{N}})) of a simulated model. In examples herein, the sample subsets repository 120 may include multiple subsets of M samples for use in performing a fast simulation in accordance with examples herein. For the sake of readability and examples herein, the sample subsets repository 120 may be referred to as storing a single sample subset of M samples or a subset set of M samples for use in a fast simulation.

The sample subsets repository 120 of FIG. 1 includes results of precomputed simulations on subsets of samples (e.g., simulations of g(βₖ, X_{{M}})) of a simulated model, subsets of samples (inputs of the simulations), and a pre-determined parameter set of the simulated model. In some examples, the sample subsets repository 120 may hold subsets of samples (e.g., subsets of M samples from the above) and results for multiple types or sets of simulations. For the sake of examples, herein, the sample subsets repository 120 is considered to hold M preselected results/samples from precomputed N samples of a simulated model (e.g., a Monte Carlo simulation) for analysis/use by the fast simulation manager 110. The sample subsets repository 120 may include the M results (e.g., outputs) of the precomputed simulations along with parameter values, inputs, etc. The results of the precomputed simulations correspond to results of a simulated model executed multiple times with various values for parameters (e.g., βₖ) of the simulation. In some examples, the fast simulation manager 110 may generate the results of the precomputed simulations stored in the sample subsets repository 120 by precomputing the simulations of the simulated model (e.g., prior to going “online,” prior to receiving a request from the simulation requestor 130, etc.). The results/samples in the sample subsets repository 120 are considered precomputed in that they are determined prior to the fast simulation manager 110 performing a fast simulation of the simulated model for a set of test parameters.

In some examples, the sample subsets repository 120 may store results of the simulation of g(βₖ, X_{{N}}), results of the simulation of g(βₖ, X_{{M}}) and sample subsets X_{{M}} for large numbers (e.g., one hundred, one thousand, etc.) of different values of βₖ. As such, due to the magnitude of K and M, a large shared memory structure may be used to implement the sample subsets repository 120. For example, the sample subsets repository 120 and/or any other storage device storing samples (e.g., a database storing the M samples) may be implemented by a cluster of memory devices. In some examples, the sample subsets repository 120 may be implemented by a persistent, byte-addressable memory that includes a memory fabric. Accordingly, such memory implementations may allow simulations for large values of N (e.g., over one million samples, over ten million samples, etc.).

In examples herein, a Monte Carlo simulation, such as from Equation 3, may become the following optimization problem to select and use the M samples from the sample subsets repository 120:

$$min {E ( ( {\sum }_{k} {α}_{k} ( g ( {β}_{k} , {X}_{1 : N} ) + g ( θ , {X}_{\{ M \}} ) - g ( {β}_{k} , {X}_{\{ M \}} ) ) ) - E ( f ( X , θ ) ) )}^{2} \qquad ( 8 )$$

such that the memory space of the sample subsets repository 120 allocated for the fast simulation is greater than or equal to the memory space to store number of samples selected (M) by the number of parameter sets to be tested (K) (i.e., M×K≤Allocated Memory).

The example values of the parameter set βₖ of each execution of the simulation (used to determine the simulation results for both the complete set of samples (N) and for subset of samples (M) in the sample subsets repository 120) are predetermined. For example, the parameters βₖ may be random, uniform, expected, or common values for a simulated model in a given simulation, such as the simulation of Equations 6 and 7. The sample subsets repository 120 may be structured such that it can be referenced for use when receiving test parameter set for θ from the fast simulation requestor 130. As such, the sample subsets repository 120 may implement a data structure (e.g., an index, table, etc.) to identify corresponding precomputed results of the simulation based on a set of test parameter values received from the fast simulation requestor 130. For example, the data structure of the sample subsets repository 120 may enable the fast simulation manager 110 to retrieve simulation results having certain values for βₖ based on received test parameters for 9 for Equations 6 and 7.

Furthermore, in some examples, the example sample subsets repository 120 may be in communication with the fast simulation manager 110 via a network. Accordingly, the sample subsets repository 120 may be located or simulated within a cloud system (e.g., a network of servers and/or other computing devices) in communication with the fast simulation manager 110. In such examples, a device implementing the fast simulation manager 110 may not store the precomputed results of the sample subsets repository 120 and the precomputed results may be determined offline.

The example fast simulation requestor 130 requests the fast simulation manager 110 to perform a fast simulation for a set of test values for parameters (e.g., the parameters 9 of the above simulation) of a simulation. For example, the fast simulation requestor 130 may send a request message that indicates a test simulation fora simulated model (e.g., g(θ, X)), test parameter sets for parameters of the simulated model (e.g., for the parameters θ above), etc. The fast simulation manager 110 may then facilitate a fast simulation of the simulated model for the test parameter sets in accordance with examples herein. The fast simulation requestor 130 may be implemented by a user interface that enables a user to send the request. In some examples, the request may be sent or provided automatically (e.g., in response to characteristics or a subject of the simulated model, such as a market or changes to a market).

The fast simulation manager 110, described in more detail in connection with FIG. 2, performs a fast simulation using test parameter sets (e.g., for the parameters θ) requested by the fast simulation requestor 130. The fast simulation manager 110 may then forward results of the fast simulation to the fast simulation results provider 140. The example fast simulation results provider 140 may present (e.g., via a display device) or provide results of the fast simulation. In some examples the fast simulation results provider 140 may return or provide the results of the fast simulation to the fast simulation requestor 130. The fast simulation results provider 140 may include or be implemented by a user interface (e.g., a display, a speaker, etc.) that provides the results of the fast simulation performed by the fast simulation manager 110.

FIG. 2 is a block diagram of an example implementation of a fast simulation manager 110 that may be used to implement the fast simulation manager 110 of FIG. 1. The fast simulation manager 110 of FIG. 2 includes a request analyzer 210, a sample selector 220, and a fast simulator 230. In examples herein, the request analyzer 210 analyzes requests from the fast simulation requestor 130 to determine test parameter sets (e.g., values for θ in Equations 6 and 7) for a fast simulation of a simulated model, the sample selector 220 selects sample subsets for storage in the sample subsets repository 120 and test samples from the sample subsets repository 120, and the fast simulator 230 executes (e.g., computes) a fast simulation for the test parameter sets based on the results corresponding to the test sample set selected by the sample selector 220.

The example request analyzer 210 receives fast simulation requests from the fast simulation requestor 130 of FIG. 1. The example fast simulation request may include a simulated model and test parameter set(s) corresponding to parameter(s) (e.g., the parameters θ of Equations 6 and 7) of the simulated model for which the fast simulation manager 110 of FIG. 2 is to perform a fast simulation. The example request analyzer 210 may analyze the request and identify test parameter information (e.g., test parameter identifier(s), test parameter set(s), etc.). The request analyzer 210 may provide the test parameter information to the sample selector 220.

In examples, herein, the sample selector 220 preselects the M samples for fast simulation of a simulated model for storage in the sample subsets repository 120 prior to receiving the fast simulation request from the fast simulation requestor 130. For example, the sample selector 220 may use the optimization analysis of Equation 8 to select the sample subset X_{{M}}. More specifically, the sample selector 220 may perform a distance analysis, such as a Kolmogorov-Smirnov distance analysis, to select a subset of M samples from a set of N samples. For example, the sample selector 220 may perform the following analysis:

X_{{M}}=arg min d_{KS}(X_{{N}},Y_{{M}}) (9)

where X and Y are drawn from a same statistical distribution, with the statistical expectation being taken over values of the test parameter set θ. The expectation of Equation 9 may be minimized over the sets of αₖ and βₖ and d_{KS} denotes the Kolmogorov-Smirnov distance.

In examples herein, the sample selector 220 weights the selected subsets of samples corresponding to parameter sets βₖ using αₖ based on a metric distance between βₖ and the test parameter set θ. For example, αₖ may equal 1 (αₖ=1) when a βₖ values are near the value of the test parameter set θ, αₖ may equal 0 (αₖ=0) or nearer to zero when βₖ values are far from the value of the test parameter set θ. In examples herein, minimizing a distance between the βₖ values of the samples and the test parameters θ, allows the distribution of the sample set X_{{M}} as close to X_{{N}} as possible, and as such, the M samples in the analysis may act (or appear) as though there are N samples (i.e., the denominator in Equation 5 is close to α(N)).

The example sample selector 220 selects a test sample set from the sample subsets repository 120 based on the values of the test parameter set received in the fast simulation request. For example, the sample selector 220 may select sample subsets from the sample subsets repository 120 that used similar values (e.g., for βₖ) for the corresponding parameters of the simulation as the value(s) of the test parameter set(s) (e.g., the θ of Equations 6 and 7). The example sample selector 220 may use a distance analysis in selecting the test sample set from the sample subsets repository 120. For example, the sample selector 220 may select the test samples that are nearest in value to the test parameter set.

Further, based on the distance analysis between the test parameter set and the parameter sets corresponding to the sample subsets in the sample subsets repository 120, the set selector 220 may select one or more sample subsets to form the test sample set. For example, the sample subsets may be selected based on a top threshold number (e.g., top one thousand, one hundred, etc. based on the distance calculation), a threshold distance (e.g., all parameter sets that fall within a distance of the test parameter based on the distance analysis), or any other suitable threshold determination using the distance analysis. Accordingly, using the values of the test parameter set, the sample selector 220 determines a test sample set from the sample subsets repository 120 for use in executing a fast simulation of the simulation using the test parameter sets.

The sample selector 220 provides the test sample set to the fast simulator 230. The example fast simulator 230 computes the simulation (e.g., the simulation g(θ, X_{{N}}) from Equation 6) using the parameter sets βₖ corresponding to the sample subsets selected from the repository and the test parameter set θ. For example for test parameter set θ, the fast simulator 230 may perform a fast simulation to compute g(θ, X_{{N}}) from Equation 6, where g(βₖ, X_{{N}}) and g(βₖ, X_{{M}}) (from Equation 7) are retrieved from the sample subsets repository 120. For example, the fast simulator 230 may determine a difference between a simulation using the test parameter set (i.e., g(θ, X_{{M}})) and a simulation using the predetermined values for the parameters (i.e., g(βₖ, X_{{M}})), which can be retrieved from the sample subsets repository 120. Then, using known computed results for the simulation for the predetermined values across the set of N samples (i.e., g(βₖ, X_{{N}})), which can be retrieved from the sample subsets repository 120, the fast simulator 230 can compute g(θ, X_{{N}}). Accordingly, because βₖ and X_{{N}} (and thus X_{{M}}) are precomputed, the fast simulator 230 may simply retrieve the results from the sample subsets repository 120 and compute g(θ, X_{{M}}) in real-time. As such, rather than computing N simulations to get g(θ, X_{{N}}) for test parameter set θ, the fast simulator 230 computes g(θ, X_{{M}}) in real-time for the test parameter set θ and extrapolates these results to the entire sample set N using the precomputed values for (βₖ, X_{{N}}) and g(βₖ, X_{{M}}) from the sample subsets repository 120. Accordingly, using the precomputed results, the fast simulator 230 may determine g(θ, X_{{N}}) from Equation 6 for the test parameter set θ using a much smaller sample set M.

In some examples, the fast simulation manager 110 may utilize a Taylor series expansion for approximation. In some examples, when X from the simulated models above is one-dimensional and ƒ can be evaluated at equally distant points Uₖ, a real line can be divided into segments k, where each segment is centered around Uₖ. Then, for a given X within a segment j,

$$\begin{matrix}{α}_{k} = \{ \begin{matrix}1 , k = j \\ 0 , k \neq j\end{matrix} and & ( 10 ) \\ g ( {β}_{k} , X ) = f ( {U}_{k} ) and & ( 11 ) \\ h ( θ , {β}_{k} , X ) = {\sum }_{i} {f}^{i} ( {U}_{k} ) \frac{{( X - {U}_{k} )}^{j}}{factorial ( i )} & ( 12 )\end{matrix}$$

such that Equation 12 represents an order of terms of a Taylor expansion of ƒ (X) around Uⱼ.

While an example manner of implementing the fast simulation manager 110 of FIG. 1 is illustrated in FIG. 2, at least one of the elements, processes and/or devices illustrated in FIG. 2 may be combined, divided, re-arranged, omitted, eliminated and/or implemented in any other way. Further, the request analyzer 210, the sample selector 220, the fast simulator 230 and/or, more generally, the example fast simulation manager 110 of FIG. 2 may be implemented by hardware and/or any combination of hardware and executable instructions (e.g., software and/or firmware). Thus, for example, any of request analyzer 210, the sample selector 220, the fast simulator 230 and/or, more generally, the example fast simulation manager 110 could be implemented by at least one of an analog or digital circuit, a logic circuit, a programmable processor, an application specific integrated circuit (ASIC), a programmable logic device (PLD) and/or a field programmable logic device (FPLD). When reading any of the apparatus or system claims of this patent to cover a purely software and/or firmware implementation, at least one of request analyzer 210, the sample selector 220, and/or the fast simulator 230 is/are hereby expressly defined to include a tangible machine readable storage device or storage disk such as a memory, a digital versatile disk (DVD), a compact disk (CD), a Blu-ray disk, etc. storing the executable instructions. Further still, the example fast simulation manager 110 of FIG. 2 may include at least one element, process, and/or device in addition to, or instead of, those illustrated in FIG. 2, and/or may include more than one of any or all of the illustrated elements, processes and devices.

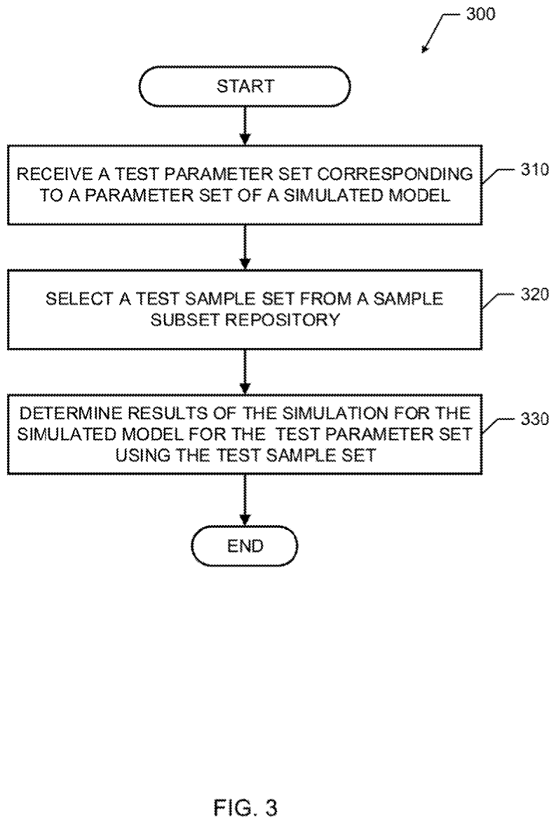

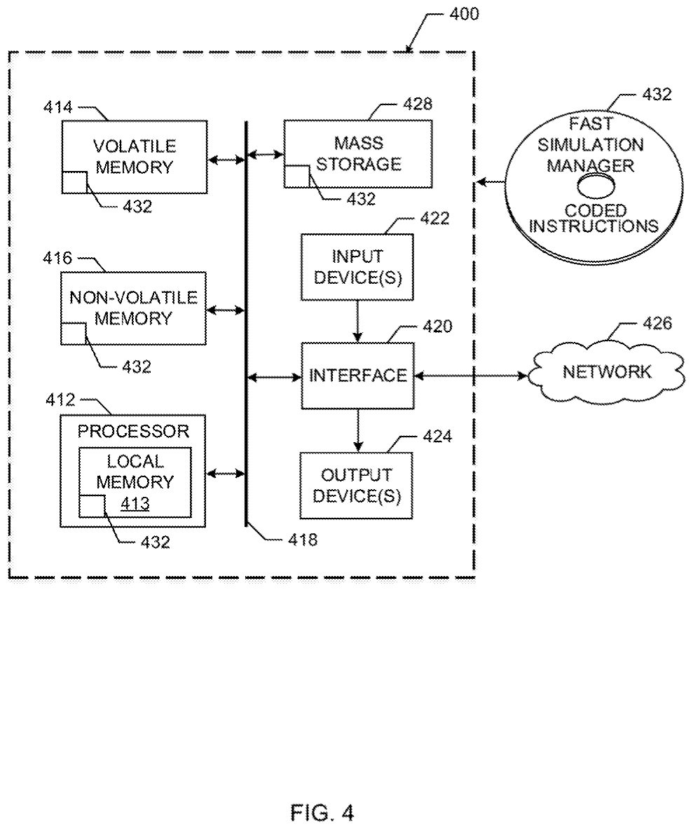

A flowchart representative of example machine readable instructions for implementing the fast simulation manager 110 of FIG. 2 is shown in FIG. 3. In this example, the machine readable instructions comprise a program/process for execution by a processor such as the processor 412 shown in the example processor platform 400 discussed below in connection with FIG. 4. The program/process may be embodied in executable instructions (e.g., software) stored on a tangible machine readable storage medium such as a CD-ROM, a floppy disk, a hard drive, a digital versatile disk (DVD), a Blu-ray disk, or a memory associated with the processor 412, but the entire program/process and/or parts thereof could alternatively be executed by a device other than the processor 412 and/or embodied in firmware or dedicated hardware. Further, although the example program is described with reference to the flowchart illustrated in FIG. 3, many other methods of implementing the example fast simulation manager 110 may alternatively be used. For example, the order of execution of the blocks may be changed, and/or some of the blocks described may be changed, eliminated, or combined.

The example process 300 of FIG. 3 begins with an initiation of the fast simulation manager 110 (e.g., upon startup, upon instructions from a user, upon startup of a device implementing the fast simulation manager 110 (e.g., the fast simulation system 100), etc.). The example process of FIG. 3 may be executed to perform a fast simulation for test parameters (e.g., for the test parameter set θ) using pre-computed results of a simulation. In the illustrated example, at block 310, the request analyzer 210 receives a test parameter set corresponding to a parameter set of a simulated model. For example, at block 310, the request analyzer 210 may receive a request comprising simulation and/or parameter information (e.g., values for the parameters of the parameter set θ) for use in a fast simulation. The example request analyzer 210 may analyze, parse, etc. the message to identify the test parameter set for the fast simulation.

At block 320 of FIG. 3, the sample selector 220 selects a test sample set from the sample subsets repository 120. For example, the sample selector 220 may select samples from the sample subsets repository 120 based on the predetermined simulation parameter values (e.g., for βₖ). For example, at block 320, the sample selector 220 may perform a distance analysis between the values for the test parameter set θ and the βₖ. In some examples, at block 320, the sample selector 220 may apply a weight (e.g., αₖ) to each sample subset.

At block 330 of FIG. 3, the example fast simulator 230 determines results of the simulation for the simulated model for the test parameter set using the test sample set. For example, at block 330, the fast simulator 230 may compute a simulation (e.g., Equations 6 and 7) using the pre-computed results (e.g., g(βₖ, X_{{N}}) and g(βₖ, X_{{M}})) and perform a real-time simulation for the test parameter set values using the selected samples (e.g., X_{{M}}). For example, the fast simulator 230 may apply the test parameter set θ to the test sample set to obtain g(θ, X_{{M}}). Accordingly, at block 330, the fast simulator 230 may perform a real-time simulation for the test parameter set on a selected subset of cardinality (M) rather than performing a real-time calculation for the test parameters using the entire sample set of cardinality (N). As such, at block 330, the fast simulator 230 may determine a difference between a simulation using the test parameter set (i.e., g(θ, X_{{M}})) and a simulation using the predetermined values for the parameters (i.e., g(βₖ, X_{{M}})). Then, using known computed results for the simulation for the predetermined values across the set of N samples (i.e., g(βₖ, X_{{N}})), the fast simulator 230 can compute g(θ, X_{{N}}). After block 330, the example process 300 ends. In some examples, after block 330, the results of the fast simulation may be provided (e.g., transmitted, displayed, etc.) to a user or other device (e.g., via the results provider 140).

As mentioned above, the example processes of FIG. 3 may be implemented using coded instructions (e.g., computer and/or machine readable instructions) stored on a tangible machine readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible machine readable storage medium is expressly defined to include any type of machine readable storage device and/or storage disk and to exclude propagating signals and to exclude transmission media. As used herein, “computer readable storage medium” and “machine readable storage medium” are used interchangeably. Additionally or alternatively, the example processes of FIG. 3 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory machine readable medium is expressly defined to include any type of machine readable storage device and/or storage disk and to exclude propagating signals and to exclude transmission media.

As used herein, when the phrase “at least” is used as the transition term in a preamble of a claim, it is open-ended in the same manner as the term “comprising” is open ended. As used herein the term “a” or “an” may mean “at least one,” and therefore, “a” or “an” do not necessarily limit a particular element to a single element when used to describe the element. As used herein, when the term “or” is used in a series, it is not, unless otherwise indicated, considered an “exclusive or.”

FIG. 4 is a block diagram of an example processor platform 400 capable of executing the instructions of FIG. 3 to implement the fast simulation manager 110 of FIG. 2. The example processor platform 400 may be or may be included in any type of apparatus, such as a server, a personal computer, a mobile device (e.g., a cell phone, a smart phone, a tablet, etc.), a personal digital assistant (PDA), an Internet appliance, a DVD player, a CD player, a digital video recorder, a Blu-ray player, a gaming console, a personal video recorder, a set top box, or any other type of computing device.

The processor platform 400 of the illustrated example of FIG. 4 includes a processor 412. The processor 412 of the illustrated example is hardware. For example, the processor 412 can be implemented by at least one integrated circuit, logic circuit, microprocessor or controller from any desired family or manufacturer.

The processor 412 of the illustrated example includes a local memory 413 (e.g., a cache). The processor 412 of the illustrated example is in communication with a main memory including a volatile memory 414 and a non-volatile memory 416 via a bus 418. The volatile memory 414 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 416 may be implemented by flash memory and/or any other desired type of memory device. Access to the main memory 414, 416 is controlled by a memory controller.

The processor platform 400 of the illustrated example also includes an interface circuit 420. The interface circuit 420 may be implemented by any type of interface standard, such as an Ethernet interface, a universal serial bus (USB), and/or a peripheral component interconnect (PCI) express interface.

In the illustrated example, at least one input device 422 is connected to the interface circuit 420. The input device(s) 422 permit(s) a user to enter data and commands into the processor 412. The input device(s) can be implemented by, for example, an audio sensor, a microphone, a camera (still or video), a keyboard, a button, a mouse, a touchscreen, a track-pad, a trackball, isopoint and/or a voice recognition system.

At least one output device 424 is also connected to the interface circuit 420 of the illustrated example. The output device(s) 424 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), a printer and/or speakers). The interface circuit 420 of the illustrated example, thus, may include a graphics driver card, a graphics driver chip or a graphics driver processor.

The interface circuit 420 of the illustrated example also includes a communication device such as a transmitter, a receiver, a transceiver, a modem and/or network interface card to facilitate exchange of data with external machines (e.g., computing devices of any kind) via a network 426 (e.g., an Ethernet connection, a digital subscriber line (DSL), a telephone line, coaxial cable, a cellular telephone system, etc.).

The processor platform 400 of the illustrated example also includes at least one mass storage device 428 for storing executable instructions (e.g., software) and/or data. Examples of such mass storage device(s) 428 include floppy disk drives, hard drive disks, compact disk drives, Blu-ray disk drives, RAID systems, and digital versatile disk (DVD) drives.

The coded instructions 432 of FIG. 3 may be stored in the mass storage device 428, in the local memory 413 in the volatile memory 414, in the non-volatile memory 416, and/or on a removable tangible machine readable storage medium such as a CD or DVD.

From the foregoing, it will be appreciated that the above disclosed methods, apparatus and articles of manufacture provide for a simulation (i.e., a fast simulation) of a simulated model for a test parameter set using precomputed results of simulations of the simulated model. In examples herein, fast simulation may be performed that increases the speed of computing a simulation by using precomputed simulation results. In examples herein, a sample set is selected to represent a full set of samples for computing a simulation (e.g., a Monte Carlo simulation). By applying the test parameter set to the sample set and determining a difference between the sample set with the test parameters and the sample set with predetermined parameter values, the simulation can be computed for the test parameter set with greatly increased speed. For example, for a total of N samples, and M subsamples selected from the N samples where M<<N (e.g., at least one thousand times smaller), the speed of computing the simulation across N samples using the selected M subsamples can increase by N/M.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A method comprising:
receiving a test parameter set corresponding to a parameter set of a simulated model;
selecting a test sample set from a sample subsets repository, wherein the sample subsets repository consists of precomputed simulation sample subsets with each simulation sample subset corresponding to a parameter set;
determining a result of the simulation for the simulated model for the test parameter set using the test sample set.

2. The method as defined in claim 1, wherein the sample subsets repository and the said parameter sets are predetermined and precomputed prior to the receiving of the said test parameter set.

3. The method as defined in claim 1, wherein a simulation sample subset corresponding to a parameter set is selected from members of a simulation sample set corresponding to the said parameter set, wherein the said simulation sample set follows the statistical distributions determined by the said parameter set.

4. The method as defined in claim 3, wherein the simulation sample subset is selected from members of the simulation sample set by minimizing a statistical distance between the sample subset and the sample set constraint by the cardinality of the sample subset.

5. The method as defined in claim 1, further comprising selecting the test sample set based on a distance analysis between the test parameter set and the parameter sets corresponding to the simulation sample subsets.

6. The method as defined in claim 5, further comprising applying weights to each member of the test sample set based on the distance analysis; and using the weights to determine the result of the simulation.

7. The method as defined in claim 1, wherein the size of the sample subsets repository corresponds to an amount of memory of a system allocated to compute the simulation.

8. The method as defined in claim 1, wherein the simulation comprises a Monte Carlo simulation that utilizes a plurality of samples to determine a result.

9. The method as defined in claim 1, further comprising determining the simulation result by determining a difference between a result of a simulation using the test parameter set and a result of a simulation using one or more parameter sets corresponding to the simulation sample subsets, wherein the simulations are run using the test parameter set.

10. An apparatus comprising:
a request analyzer to identify the test parameter set for a simulated model;
a sample set selector to select a test sample set from a sample subsets repository, each subset in the sample subsets repository generated during a prior simulation run of the said model using a predetermined parameter set; and
a fast simulator to determine a result of the simulation for the test parameter set using test sample set by computing differences between simulations for the test parameter set and for one or more parameter sets corresponding to subsets in the sample subsets repository.

11. The apparatus of claim 10, wherein the sample set selector is further to perform a distance analysis to select the test sample set, the distance analysis based on the distance between the test parameter set and parameter sets corresponding to the simulation sample subsets of the sample subsets repository.

12. The apparatus of claim 10, wherein the sample set selector is to select the test sample set based on an optimization that minimizes a difference between an expectation of a result of the simulation of the simulated model and a result obtained by a simulation of the simulated model that uses the results of the precomputed simulations and test sample set.

13. A non-transitory machine readable medium comprising instructions that, when executed, cause a machine to at least:
determine a test parameter set for a simulated model in a simulation request;
select a test sample set for computing a simulation result of the simulated model, the test sample set selected from a sample subsets repository of precomputed simulation results based on parameter sets; and
computing the simulation result by applying the test parameter set to the test sample set and using precomputed simulation results.

14. The non-transitory machine readable medium of claim 13, wherein the instructions, when executed further cause the machine to:
retrieving results of precomputed simulations using the predetermined values from a sample subsets repository, wherein the sample subsets repository comprises a persistent, byte-addressable memory accessible via a memory fabric.

15. The non-transitory machine readable medium of claim 13, wherein the instructions, when executed further cause the machine to:
select the test sample set based on a distance analysis, the distance analysis comprising determining a distance between the test parameter set and parameter sets corresponding to the simulation sample subsets in the sample subsets repository.

16. The non-transitory machine readable medium of claim 13, wherein the instructions, when executed cause the machine to:
determine the difference between a simulation when applying the test parameter set to the test sample set and a simulation applying one or more parameter sets corresponding to the said simulation sample subsets to the test sample set.
